(19) United States
(12) Patent Application Publication
(10) Pub. No.: US 2003/0158845 A1
(43) Pub. Date: Aug. 21, 2003

(54) Integrated management database

(76) Inventor: Gary Braley, New Brighton, MN (US)

Correspondence Address: CARLSON, GASKEY & OLDS, P.C., 400 WEST MAPLE ROAD, SUITE 350, BIRMINGHAM, MI, 48009, US

(21) Appl. No.: 10/319,729

(22) Filed: Dec. 13, 2002

Related U.S. Application Data
(60) Provisional application No. 60/341,316, filed on Dec. 13, 2001.

(51) Int. Cl. G06F 7/00

(52) U.S. Cl. 707/7

(57) ABSTRACT

This invention is a management system and method executed on a computer system as part of a computer program utilizing a computer database for integrating all types of management information pertaining to activities conducted and data gathered by an organization.

This application claims priority to U.S. provisional application serial No. 60/341,316 filed on Dec. 13, 2001.

### BACKGROUND OF INVENTION

The subject invention is an integrated management database for tracking, and organizing all elements and processes involved in managing activities and resources.

Typically, a management issue surfaces as an idea or problem, and is next addressed as an agenda item at a meeting. From the meeting, tasks are assigned and progress is measured and tracked. Currently, many different agenda items, task assignments, and ideas are stored in several different and incompatible formats. Meetings are held with multiple team members and little documentation of what was said and done, leaving many items to be discussed over and over at future meetings. Details are often missed and critical personal not included in problem solving. A manager must amass and track all items by note taking in a planner, simply memorizing information or locating misfiled information.

Many different methods and products are available to track projects, flow chart process, and track assignments, communicate ideas and mark progress. However, each product or method is separate such that several methods or products are required, thereby leaving the same problem. Information stored in many different locations with no reasonable or logical way to track or obtain information about one item from each of the many locations.

Accordingly, it is desirable to store and process management information and ideas in a way that can be logically tracked and organized for easy retrieval, distribution and communication to those involved in the project.

### SUMMARY OF INVENTION

This invention is a management system and method executed on a computer system as part of a computer program for managing information pertaining to activities conducted and data gathered by an organization.

The system includes a database for storing various information items. The information items include any relevant information or activity that contribute to efficient operation and successful completion of a management activity. All information items are stored in a fully searchable database for retrieval by any member of the organization. Each information item is assigned a unique identification code that remains tied to the information item. The information item is changed as needs and circumstances dictate. Each information item is initially classified according to predefined criteria. In one embodiment of this invention, an information item is classified as a problem. The problem can than be changed to a task once assigned to a person or team. The task is than tracked and updated with status and timing as well as proposed solutions or any other information relevant to the task. All information relevant to the original information item identified by the original identification code are recorded and tied to the identification code. This provides a complete history of the information from the original issue or problem to the final resolution and completion.

An embodiment of this invention is a method for managing information pertaining to activities conducted and data gathered by an organization relevant to projects and other management activities including the steps of inputting information items into a predefined form stored within the computer database and assigning an identification number to each information item. Each information item is initially classified according to a predefined criteria and then storing within a key word searchable computer database that allows retrieval of specific information items according to a specified search criteria.

Accordingly, the method and system of this invention provide a comprehensive information management tool for managing all types of information, while enabling information to be disseminated across diverse management teams and groups by accessing the searchable information database.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a schematic representation of a prior art management organization;

FIG. 2 is a schematic representation of the management system of this invention;

FIG. 3 is a main menu of the system of this invention;

FIG. 4 is an input form created for use by a Manager

FIG. 5 is a project name form;

FIG. 6, is a project task form;

FIG. 7 is a Client/Prospect problem log version of an input form;

FIG. 8 is a meeting agenda form;

FIG. 9 is a Meeting minute form;

FIG. 10 is a Meeting Agenda/Minutes form;

FIG. 11 is a Review Meeting Minutes form;

FIG. 12 is a hyperlinks form;

FIG. 13 is a Problem Report;

FIG. 14 is a Project Report; and

FIG. 15 is a block diagram illustrating some method steps.

### DETAILED DESCRIPTION OF PREFERRED EMBODIMENT

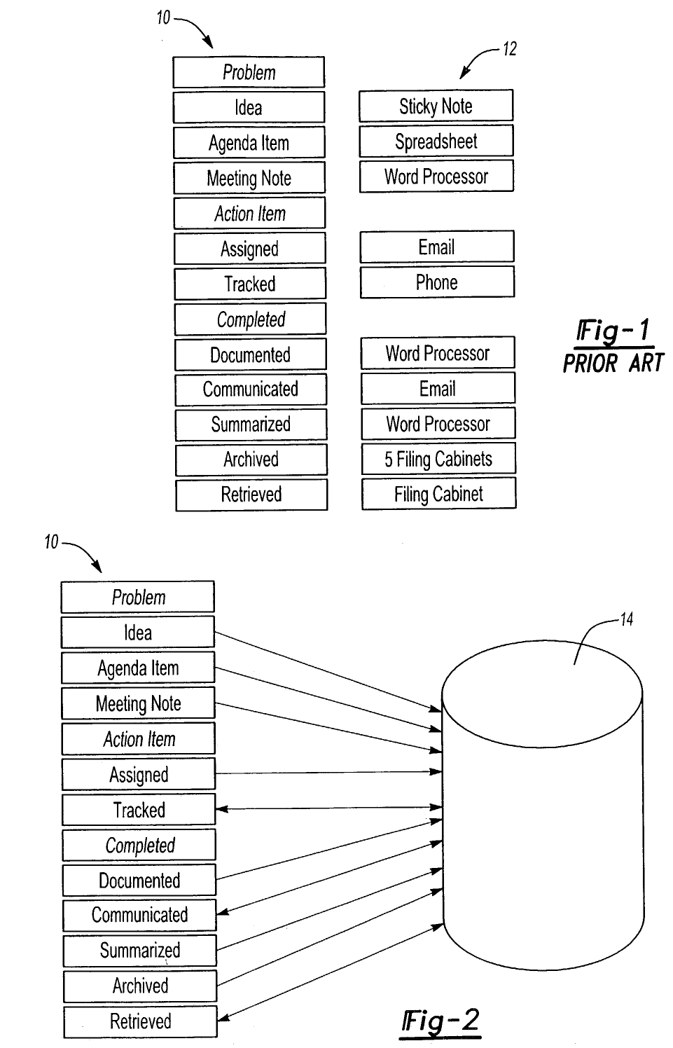

FIG. 1 is an illustration of a prior art methods of managing information in most organizations. The processes that each organization undertakes to conduct daily business, indicated at 10, include problem solving, idea generation, meeting minutes, meeting agendas, task assignment and the like. Column 12 illustrates current organization techniques and methods to process, organize and track information shown in column 10. Column 12 includes commonly known and used programs and methods that do not communicate with each other and offer no reasonable or logical means of retrieving like information from all sources.

An embodiment of this invention is a method and system of organizing and tracking information pertaining to many different projects and activities in one easily accessible database. Referring to FIG. 2, this invention includes a central database 14 in which information items 10 are input. Information stored in a central database 14 such that each information item is logically arranged and related to other common information stored within the database 14. Each information item stored in the common database 14 and is input by different members of the organization including, team members and responsible managers.

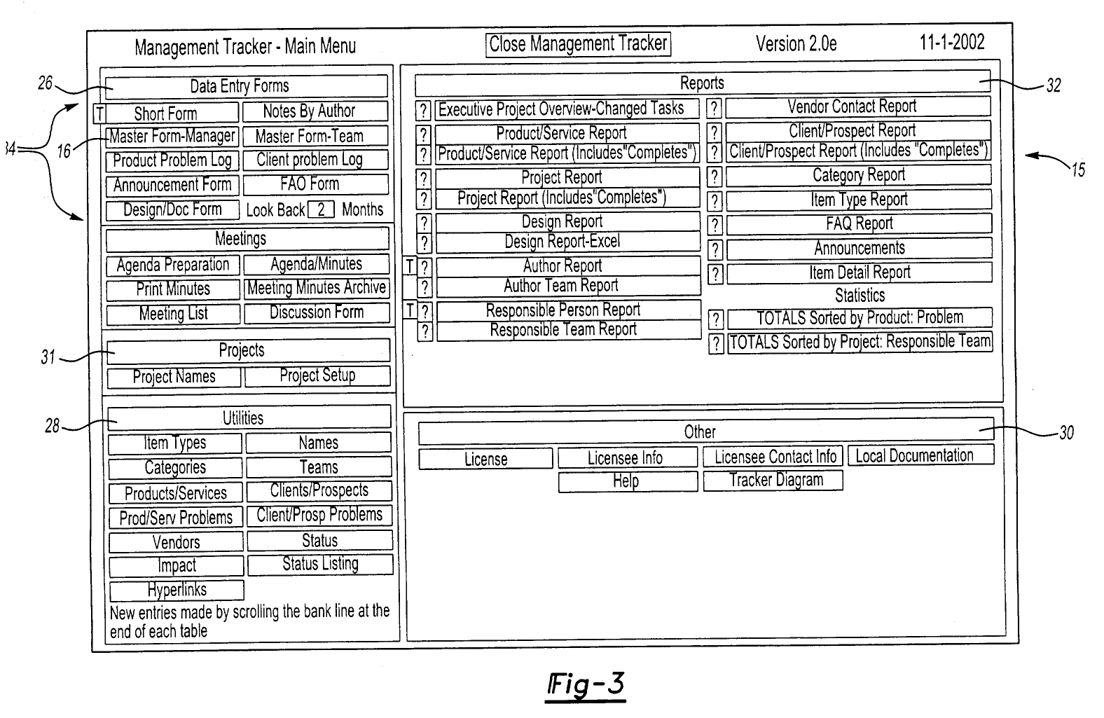

Referring to FIG. 3 the system and method of this invention includes an initial step of entering information items for storage and retrieval within the database 14.

Information is entered into the database 14 by entering specific information into one of several predefined data entry forms 34 provided at 26. FIG. 3 depicts a main menu 15 including several sections to direct the user to a desired activity, information or process step. Along with the data entry forms 26, the main menu 15 includes a utility section 28, a report section 32, a project section 31 and other information sections indicated at 30.

The data entry section 26 includes access to multiple predefined input forms 34 that are categorized for use by different users, or for different purposes. The predefined input forms 34 are modifiable according to a specific need or desire of the organization and the type of information to be tracked. The specific predefined input forms can be application specific and tailored to provide information unique to a specific organization or project.

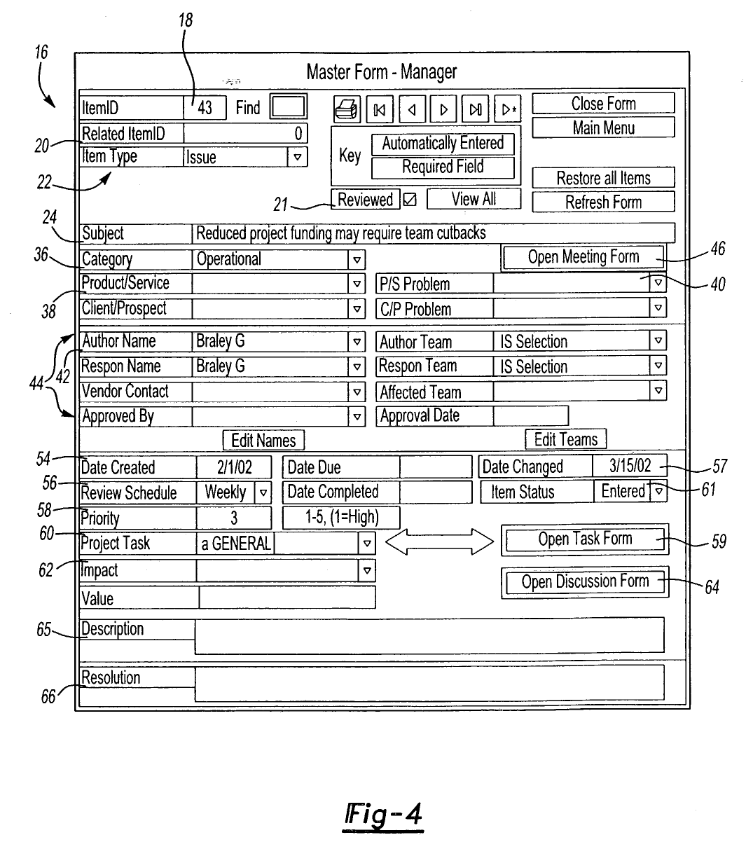

The method includes the step of inputting information into the database 14 and classifying that information according to a predefined type or category. FIG. 4 is an illustration of a data entry form 16 for use by a manager. The input form 16 includes various items that classify the information for easy retrieval from the database 14. The form includes an item number indicated at 18. The item number 18 is assigned by the system and remains the same throughout the life of the item until the item is deleted. Each information item can be updated, reclassified, and added to until reaching a final resolution or conclusion. A related item block indicated at 20 provides information on other information items that of a similar nature or subject matter and acts as a means of quick reference. Note that the item identification number 18 is a required block, while the related item block 20 is not required.

Item type, indicated at 22, contains a list of predetermined item types used to classify each particular information item for tracking and action. The item type 22 includes such classifications, as note, definition, change, problem, or any other logical classification pertaining to a specific item or action that this information should prompt. Further, the item type 22 classifies the information input into the system for retrieval by other team members for action. The database 14 is key word searchable and can be searched according to item type 22.

The data entry form 16 is directed at use by a Manager and includes data entry boxes along with a reviewed check box 21 to indicate that a specific item has been reviewed by the Manager. The box 21 provides a unique and quick reference function for a Manager. Instead of remembering information items that need to be addressed, a Manager can simply retrieve all items not yet reviewed. This function allows the Manager to quickly review information items and provide feedback and direction required to new information items as they become available

The item type 22 is modifiable to reflect progression of the information item. As an example, the item type 22 is changed to reflect the change of an issue to a problem, or to a task that is tracked until completion. During the progression from issue to completion, the same item is continually updated such that a complete history of the item is documented within the database 14.

A brief specific description of the information item is input into the subject box 24. This is a brief description of the information to aid in review and future action. Below the subject, box 24 is a category box indicated at 36. The category box 36 includes a number of predefined categories that further describe and classify the information item. Each predefined category is defined and modifiable such that the system can be adapted and modified to accommodate different organizations and project information requirements.

The date entry form 16 includes a product/service block 38 for identifying a specific resource that the item is addressing. Such products, systems or services can includes physical items such as vehicles or test equipment, or business units, or any other type of logical resource managed within an organization. These items can be predefined within the system such that a drop down menu appears and the proper selection made. The number of selections can be modified and changed to accommodate specific organization needs and requirements.

A problem/issues box 40 includes a list of predefined problem descriptions to allow for further classification and definition of the information entered into the data entry form 16. Problem types can include availability of a resource, cost, functionality, operation, performance, quality and other definitions that further classify the information item. As appreciated, the specific problem/issue description is application specific and can be tailored to support specific organization and project needs.

Author name, indicated at 42 documents the author of the person inputting data into the data entry form 16. This serves both to identify the user that generated the idea or logged in the information, and to serve as another means of classifying, and retrieving information. Team blocks 44 allow entry of predefined teams and include data for the author's team, and for the team responsible for a particular item.

Also included is a block to identify an affected team. Marking of this block initiates the alerting of a team member from an affected team not involved in the generation of the data entry form of the new information. As appreciated, one recognized problem with prior art information management methods is the dissemination of information to those not included or present in a meeting or problem solving session. This system and method of this invention provides an effective means of informing those affected of changes, additions and issues affecting items to which they are responsible. Therefore, information dissemination is not dependent on a properly routed memo or another team member remembering to include them within a meeting or distribution list.

The data entry form 16 further includes button for opening a meeting form. The meeting form is used to place items on a meeting agenda. A date created box 54 provides a space for recording the date the information item was created. Block 57 records the date that the information item or form 16 was updated or changed. Another block indicated at 56 indicates when the information within the data entry form 16 is to be reviewed. A priority Block 58 displays and records allows a priority to be attached to each information item as an aid to assigning resources for a responsible manager.

Block 59 is a button that opens project forms. Block 60 is a task box that is filled in to describe tasks stemming from the information item. This box is accompanied by an item status box 61. The item status box 61 includes a pull down menu with several predefined item status definitions to communicate current progress of a specific item. Such comments would include, completed, dropped or any other comment that provides sufficient information describing how the information item was finally resolved.

Block 62 is an impact box to document the impact that this information item has on a specific problem, task or issue. The impact block 62 relates to several different parameters, including severity of affect to other tasks, or severity of problem to indicate that resources should be applied to this item on a priority basis.

A discussion form opens in response to button 64 to provide a space for a detailed discussion of the information item. A description space 65 is also provided on the form 18 that provides a space to organize and record comments regarding the specific information item. The discussion form 64 can include a detailed description of the information item and can be used to log of each change and action taken relative to the information item. A resolution space is provided for recording a short statement on how an information item was finally resolved. As described above the data entry form 16 includes many different blocks, spaces and check boxes for the entry of information that will aid in classification of the information item and allow for the tracking of the item from inception to completion. The items described in the FIG. 4 are modifiable to include information required in specific applications such that this system can be tailored and applied to many different organizations to manage differing information types.

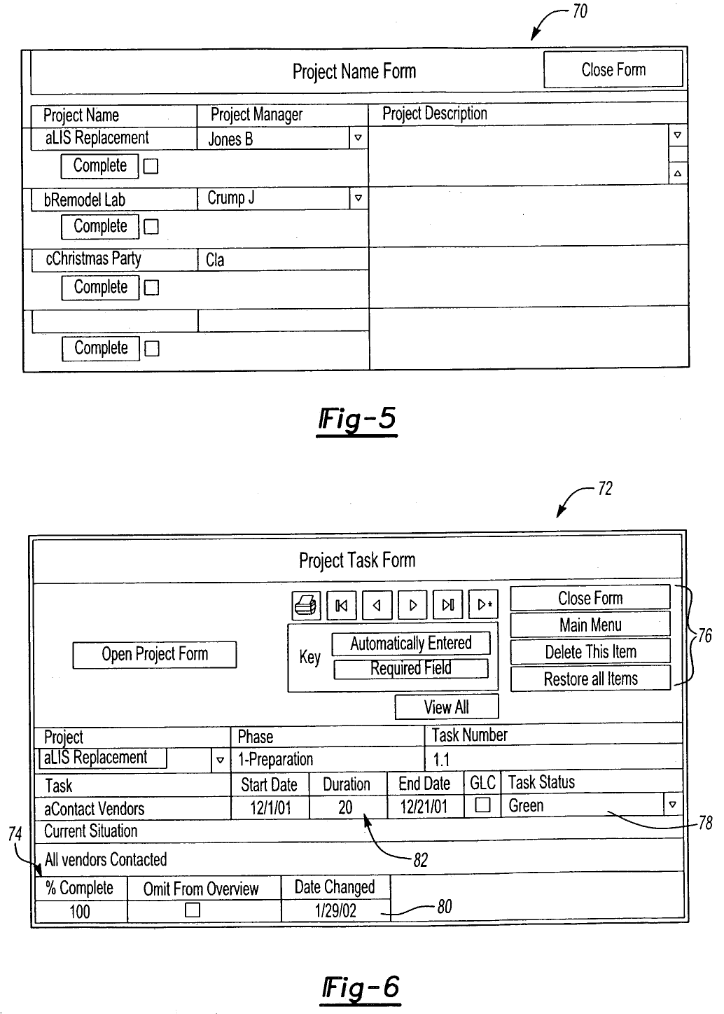

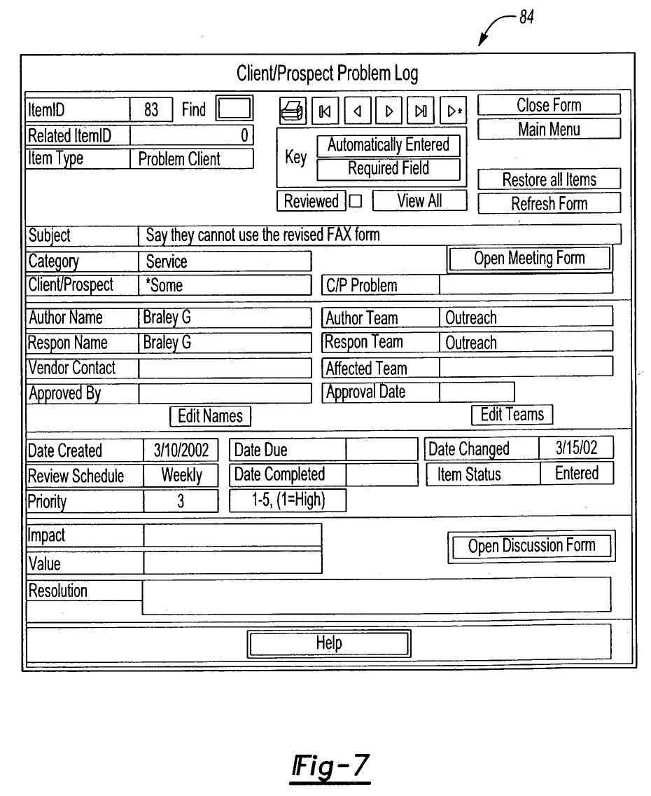

FIGS. 5 and 6 are embodiments of the data entry forms specifically tailored for setting up a specific project or task. A project name form 70 is used to initially set up and describe the project and general information relative to any project. The project name form 70 includes a list of each project created and present within the database 14.

FIG. 6, is project task form 72 that identifies information corresponding to specific tasks relevant a specific project. The project task form 72 includes a space for information relating to task status at 78 and a percent complete space 74. The duration allotted the task is recorded in a space 82. The form also includes a date-changed box 80 to identify and provide information on the last activity to the task or last modification to the task form 72. The project task form 72 also includes a navigation menu 76 to allow quick access to other information and forms present within the database 14.

FIG. 7 is a Client/Prospect problem form 84 and is specifically directed at recording problems and potential client issues. This form is specifically formatted to contain information pertaining to a specific problem that allows for classification and logical tracking of each problem according to the classification and definitions entered into the data entry form 84. The various forms illustrate the adaptability of this system and method to various different needs of specific organizations. The specific type of input form can be tailored to specific information needs and types in order to organize that information according to an organizations or

Data input into the system and classified by entering pertinent data into each of the data entry boxes provides a single location for all information from notes, to issues, to tasks such that a key word search can be conducted to view all relevant items containing a particular key word. Further, as indicated, searches can be conducted by any type of data input into the data entry form, such as by author, category, or any other data input into one of the data entry forms.

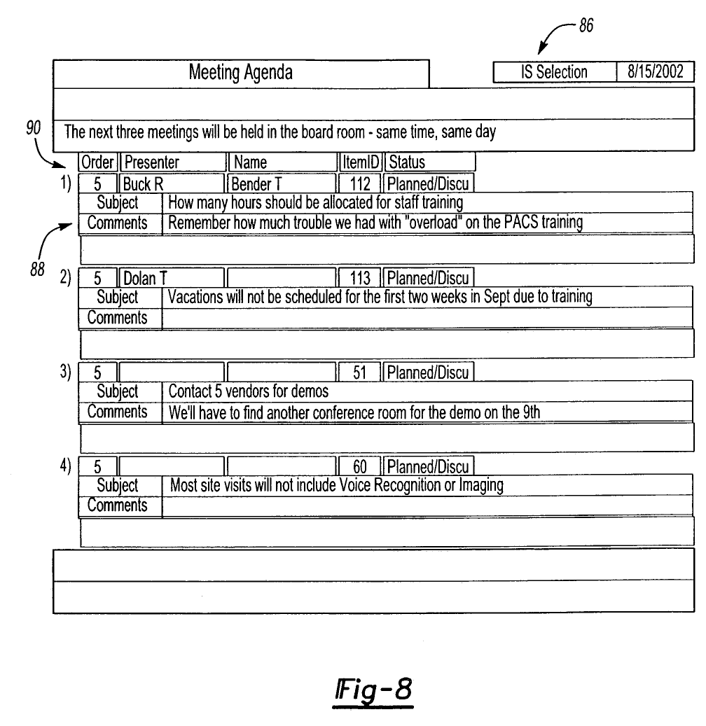

The system includes a number of predefined reports and worksheets for retrieving and arranging data contained within the central database. Referring to FIG. 8, a feature of this invention is the ease and tracking of information items to build a meeting agenda. A meeting agenda worksheet 86 is easily compiled from information items input within the system. A search for information items by team or project can be used to compile a specifically tailored meeting agenda that includes all items relevant for discussion, regardless of the source. In other words, even if a member not part of the meeting or team inputs an information item and that information item is related to issues or problems addressed, that information item is placed on the agenda. This feature allows tracking of specific problems, issues and information across several unrelated teams, such that items are addressed by teams that need or should address that information.

Preferably, in operation, a manager reviews items relevant to a meeting and can add or delete specific information items. The worksheet provides a manager with a tool to amend items input by a variety of authors to create a meeting agenda. Total time to create an agenda using the system of this invention would be minutes and include all items identified by other users, compared to prior art methods of attempting to accumulate agenda items from memory, e-mails or sticky notes that is inaccurate, incomplete and can take hours. Further, the meeting agenda worksheet 86 includes an assigned to box 90 to record the person responsible for a specific agenda item or task derived from that agenda item.

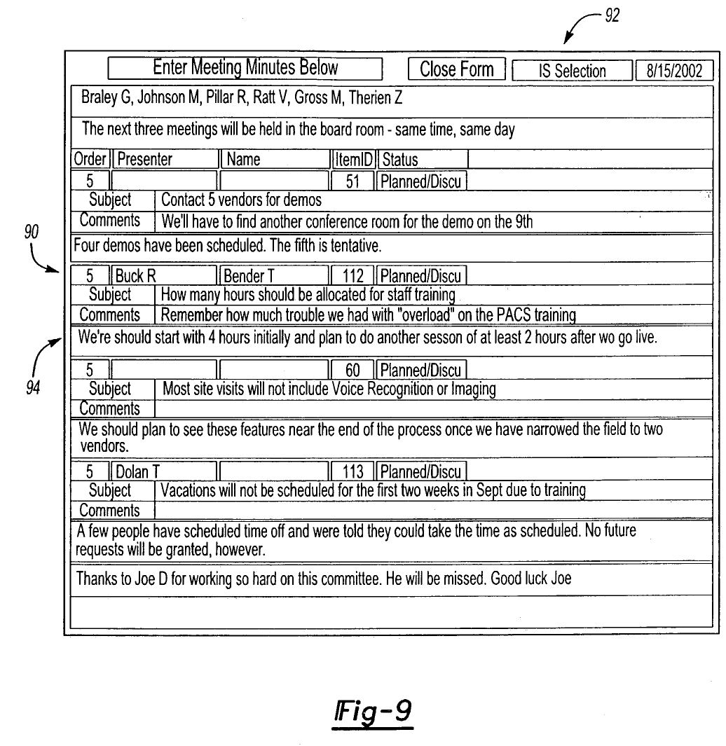

Referring to FIG. 9 a meeting minutes form 92 includes space 94 into which comments and items of discussions can entered during the meeting. Preferably, items in the meeting minutes form 92 are recorded during the meeting or immediately after the meeting. The meeting minutes are then available to any user by accessing the central database 14. This eliminates the need to print and distribute meeting minutes to team members.

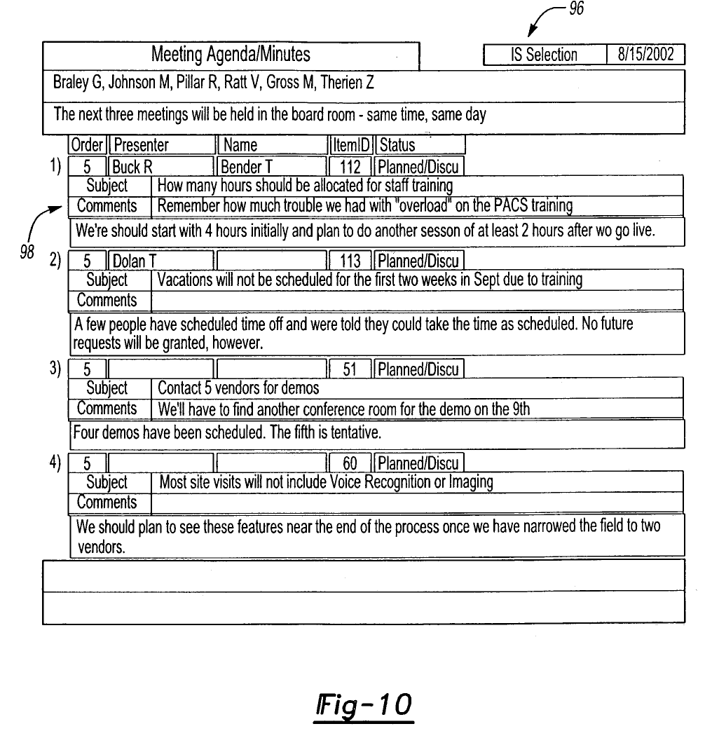

Referring to FIG. 10, a Meeting Agenda/Minutes form 96 includes a record of the agenda items and the comments made and recorded during a meeting. The comments are recorded in comment spaces 98. As appreciated, distribution of printed material is inefficient and often is not directed to all of the people who require the information. The system of this invention stores this information for retrieval by all users concerned with a particular subject, item or category of information. This process eliminates the expensive, time consuming and error prone requirements for multiple individuals to maintain paper or electronic files.

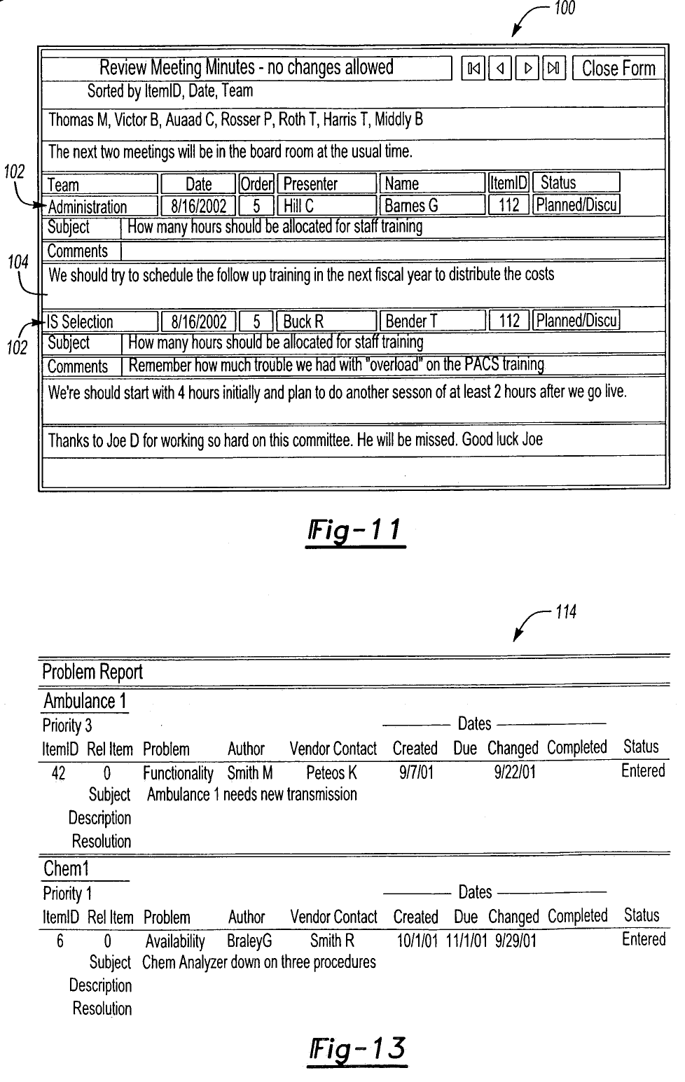

Referring to FIG. 11, the system of this invention allows for specific key word search for all information items within the database 14. This capability is enhanced by the Review meeting minutes form 100. Reviewing meeting minutes form 100 allows searching by topic, information item, project, or any other search parameter of all meeting minutes across the entire database. This provides information on specific topics and what was discussed during any of the meetings. Further, the information from any of the meetings can be arranged by team as indicated at 102. The information sorted by team 102 includes comments and discussions that identify and describe the information discussed during the meeting and is displayed in the comments box 104.

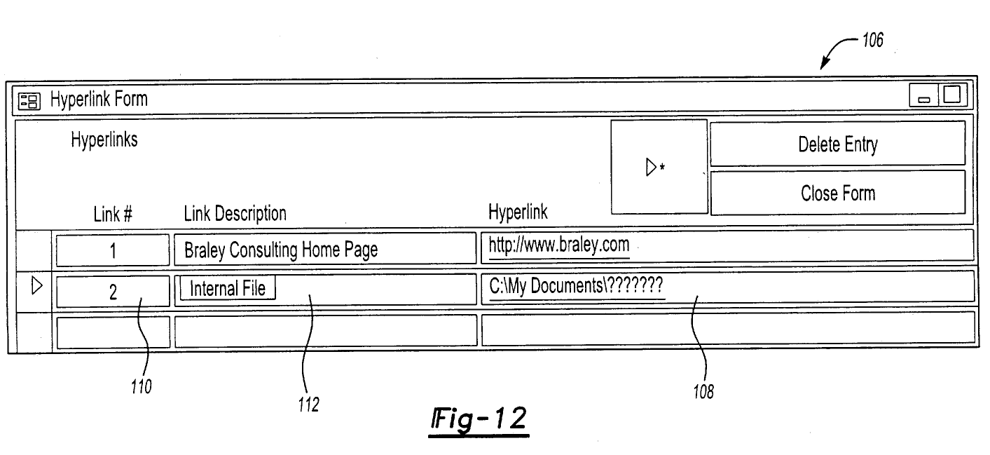

Referring to FIG. 12, a hyperlink form 106 is included and allows information outside of the database to easily referenced. As appreciated, the various information forms includes text boxes for inputting descriptions and comments. In some instances outside documents may be referred to or be useful in providing background on a specific information item. The system provides for the inclusion of hyperlinks within any of the information items to tie information stored within the database to external information of particular relevance to the specific information item. The hyperlink form includes a link number 110, a description of the link 112, and the hyperlink itself 108. As appreciated, the hyperlink 108 can provide a link to documents, websites or any other information as is known to a worker skilled in the art. The hyperlink 108 enables information from outside the database 14 to be included, and organized within the database. The hyperlink feature of this system exponentially magnifies the information managing capability of this system.

Referring to FIG. 13, another embodiment of a report form includes a problem report form indicated at 114. The problem report 114 is sorted by resource such that all the problems for any given resource currently pending are available for review. As appreciated, this is but one way of defining a problem report. The problem report may also be ordered by severity of problem, most recent problem or other criteria as desired by a user. Pertinent data concerning each problem is made available to users by accessing the central database 14 and reviewing this predefined report.

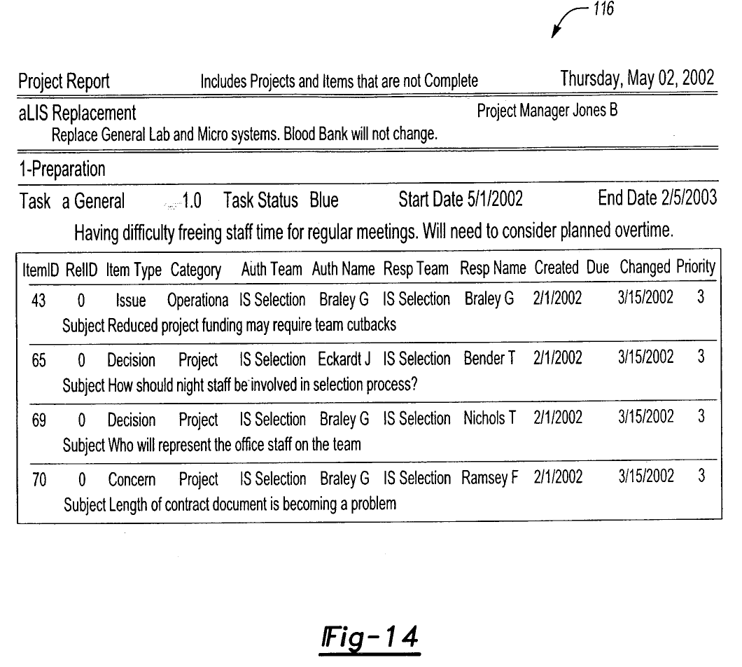

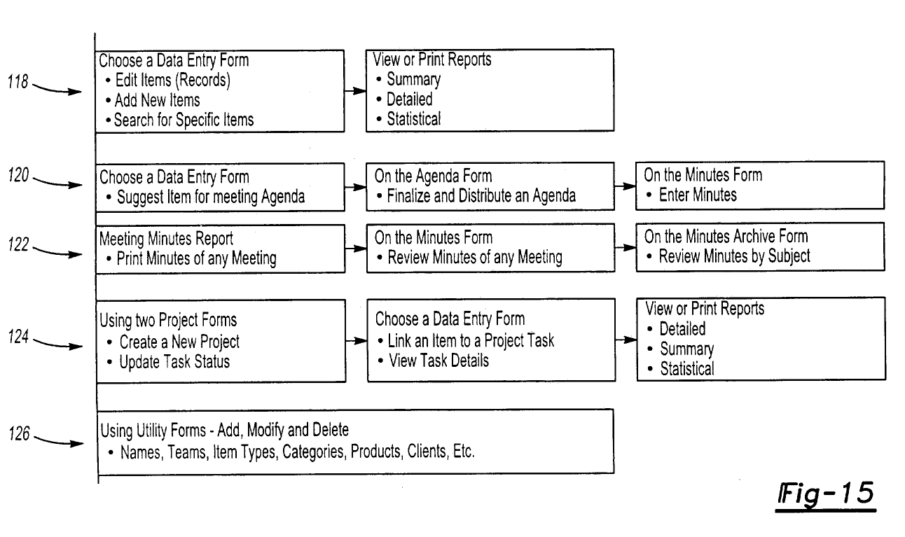

FIG. 14 is another embodiment of a predefined report form for a project report and is indicated at 116. The project report form 116 includes all tasks for a particular project arranged by priority. The report indicated at 116 includes all of the priority 3 tasks along with relevant information.

The differing types of reports included in this system are only a sample of report types available. As appreciated, because all of the information is contained in a single accessible database 14, any information input, can be used to formulate a report and sort the information items. Further, each report can be modified and adapted to accommodate specific needs and requirements.

FIG. 15 is a block diagram illustrating how the system is used for different operations to control and manage information. One primary use of the system is illustrated at 118 as inputting, editing and searching for specific information items. The information can then be printed out in predefined reports or summaries. The specific content and detail of any report or summary is adaptable to the specific organization and need. Further, the database can be used to provide statistical information item according to predefined as selected criteria.

Row 120 illustrates how information is taken from an entry form or input form and flagged as a meeting agenda item. The information item is then compiled into the meeting agenda 86. The meeting agenda 86 is distributed and a copy of the meeting minutes form 92 is used to record discussion and comments pertaining to each information item.

Row 122 shows the steps of recording, distributing and sending the meeting minutes to track progress, or research additional information required. Row 124 illustrates some of the steps in which the project forms are used. The steps include creating a new project or updating the status of an already created project and linking information items to the project. The information is then viewable and searchable by each specific project. Row 126 illustrates just some of the utility functions available within the system including adding, modifying and deleting information. The use of the database to store and manage this information allows control of information in one central location instead of across multiple software programs or filing devices.

In operation, the system and method of this invention includes the steps of a user or manager entering information into one of the predefined forms. The form includes several different information blocks to classify and define the information item. The information along with the classification and definition is stored within the database 14. Information is added to each information item as actions are taken by managers, team members and other concerned parties. As the information item is acted on, the definition and classification is modified to reflect current actions and status. As the information for the specific item is further updated, past actions or changes are saved and logged to provide a complete history from inception to completion of each item.

Including all data in a common database 14 enables a key word search to generate a report including all notes, problems, tasks, and the like pertaining to a particular item to be retrieved and viewed quickly and accurately. Further, documentation of any task, problem or note is located in a single accessible location to allow for simple report generation. The integrated nature of this system and method provides a simply easily accessible means of storing, tracking, communicating and documenting the various management activities of any organization.

Management activities of an organization include many different types of information items, all of which are valuable and important to accomplishing specific organization goals and day-to-day operations. The system of this invention organizes all management information regardless of type, content or subject. For example, announcements for distributing information to team members can be included within the database for distribution to various team members. Changes in procedure, meeting, information, policies, etc can be documented and tracked. Comments and concerns regarding any subject, topic can be recorded for future referral, and action. Opinions expressed by team members can also be recorded to provide a means of receiving input on management decisions, project progress, or specific tasks. Questions can be logged along with answers and decisions relating to those questions recorded and documented.

The system can also store definitions such that information concerning an organization or activity is readily available to those who need it. Documentation can either be stored directly within the database or referred to by hyperlinks within the database, allowing for storage and quick retrieval of relevant management documents. Documents can include contract terms, specifications for a specific device or project, proposals. Requirements for the organization including specific terms, and procedures applicable to an organization, client or customer can be stored for retrieval and reference by managers and team members alike.

The system can also include frequently asked questions along with answers to eliminate repeat efforts to answer and solve problems. The system includes and stores information in an easily searchable database, allowing management information to be quickly and easily disseminated to those who need it. Information items can be stored that relate to Issues, jobs, client problems, equipment problems or simply stored as notes if not readily definable. As appreciated, many classifications of information are valuable for management to efficiently accomplish goals and tasks. The system of this invention eliminates many of the obstacles encountered in disseminating information and allocating resources. The system of this invention allows for any type of information, no matter what format, category or use to be stored and retrieved in a logical manner. It should be understood that the information types, items, and classifications discussed in this application are only examples of management information manageable by this system, and many other types of management information fall within the scope and contemplation of this invention.

The foregoing description is exemplary and not just a material specification. The invention has been described in an illustrative manner, and should be understood that the terminology used is intended to be in the nature of words of description rather than of limitation. Many modifications and variations of the present invention are possible in light of the above teachings. The preferred embodiments of this invention have been disclosed, however, one of ordinary skill in the art would recognize that certain modifications are within the scope of this invention.

What is claimed is:

1. A method executed on a computer system as part of a computer program for integrating all types of management information pertaining to activities conducted and data gathered by an organization, said method comprising the steps of
a. inputting information items into a predefined form stored within a computer database;
b. assigning an identification number to each of said information items;
c. classifying each of said information items according to a predefined criteria;
d. storing each of said information items within said computer database; and
e. retrieving the information item according to a specified search criteria.

2. The method of claim 1, further including the step of searching all information items according to a desired criteria

3. The method of claim 1, further including the step of providing a hyperlink to information items not stored within said database within said information item, such that said system manages information external to said database.

4. The method of claim 1, including the step of defining a project and relating information items to said defined project.

5. The method of claim 1, further including the step of assigning each information item a unique identification code.

6. The method of claim 5, further including the step of reclassifying the information item in response to changes in status, and maintaining said identification code regardless of any status change.

7. The method of claim 1, including the further step of flagging the information item for review.

8. The method of claim 1, including the further step of compiling a meeting agenda from information within said database according to a desired criteria.

9. The method of claim 1, including the further step of compiling a Meeting agenda form for entering comments relevant to each information item and recording said comments into said database.

10. The method of claim 1, including the step of creating meeting records by compiling specific information items discussed during a meeting and formatting said specific information according to a predefined meeting minute report.

11. The method of claim 1, wherein said information item is a problem description.

12. The method of claim 1, wherein said retrieving step is further defined as retrieving information according to a predefined format for generating a specific output report.

13. The method of claim 12, wherein said output report is a problem log.

14. The method of claim 12, wherein said output report is a project reports.

15. An information management system for managing information pertaining to activities conducted and data gathered by an organization comprising;
a predefined input form for inputting information items relevant to an organization;
a database residing within a memory device of a computer for storing said information items,
an output form for displaying information items stored within said database according to a predefined criteria.

16. The system of claim 15, wherein said database includes a search routine for identifying those information items fulfilling a desired search criteria.

17. The system of claim 15, wherein said information item includes a hyperlink to information outside said database, such that said database manages information outside said database.

18. The system of claim 15, wherein some of said information items are retrieved and combined in said output form for compiling a report indicative of desired information.

19. The system of claim 15, wherein each of said information items includes a unique identification code, said identification code remains unchanged no matter what changes are made to said information item.

20. The system of claim 15, wherein each information item is updated in response progression of a task.

21. The system of claim 15, wherein each information item includes a predefined status indicator representing a predefined classification of said information item.
